(19) United States
(12) Patent Application Publication
(10) Pub. No.: US 2017/0163609 A1
(43) Pub. Date: Jun. 8, 2017

(54) ENCRYPTED AUDIO STREAMS TRANSCEIVING PORTABLE DEVICE AND ASSOCIATED METHOD

(71) Applicant: QUANTEC SA IN LIQUIDAZIONE, Lugano (CH)

(72) Inventor: Pierluigi PENTIMALLI, Selvazzano Dentro (IT)

(73) Assignee: QUANTEC SA IN LIQUIDAZIONE, Lugano (CH)

(21) Appl. No.: 15/303,870

(22) PCT Filed: Apr. 13, 2015
(86) PCT No.: PCT/IB2015/052673

§ 371 Date: Oct. 13, 2016

(30) Foreign Application Priority Data
Apr. 14, 2014 (CH) 00573/14

(51) Int. Cl. H04L 29/06; H04W 12/00; H04L 9/32; G06F 13/00; H04N 21/233

(52) U.S. Cl. CPC H04L 63/0428; G06F 13/00; H04N 21/233; H04L 9/32; H04W 12/00; H04L 29/06

(57) ABSTRACT

An encrypted multimedia streams transceiving method between a first and second user, includes using a device for transceiving multimedia streams connected to a respective electronic computer by both users; the method including a step of preventive activation of a free-to-air communication session between the users through a software for making multimedia communications within which the device operates in a first free-to-air transmission configuration, a step of creating an encrypted communication, within which the device operates in a second encrypted transceiving configuration; a step wherein the device causes the opening of a session for the transfer of encrypted data between the electronic computers, different from the free-to-air communication session used by the software for making calls, and at least audio data stream transceived between the two users during their communication is selectively switched between the free-to-air communication session and the encrypted data transfer session on the basis of a predefined criterion.

### TECHNICAL FIELD

The present invention refers to the field of electronic devices able to encrypt data and information in digital format in order to make them safer and in detail refers to an encrypted audio streams transceiving portable device. The present invention furthermore refers to an encrypted audio streams transceiving method.

### STATE OF THE ART

The communication technology that permits the transmission of streams of audio and/or video data on IP protocol networks, also known in one of its characterization as VoIP, is redefining with its increasing diffusion the communication standards for users in its entirety, both in case of end users, both in case of operators of media field or of telecommunication field (such as telephone carriers, service companies, ISP, access providers, and so on).

Various types of VoIP communication solutions are publicly known, mainly software types, which are integrated and/or can be integrated on computers, set-top-boxes, mobile radiotelephones, PC tablets or further similar electronic devices.

Furthermore, there are hardware products, such as cabled or cordless type VoIP phones, designed for end users at household level, SOHO, small and medium businesses, and communication solutions via IP protocol of infrastructure type on a specific network, which use gateway, VoIP proxy, gatekeeper or conference servers for processing and managing streams in VoIP streaming and, more generally, multimedia type streams.

Generally, with VoIP is defined a precise typology among the various technologies for the communication of audio and/or video media streams; because of the acquired notoriety, VoIP is often automatically referred to already known and very common software such as, for example, Skype® which thanks to the implementation of its advanced P2P (Peer to Peer) network of “SP2P” (Super P2P) type, succeeded in growing over time reaching a world level and contemporarily supporting millions of real time communications.

At the basis of VoIP there is the possibility of transmitting a coded voice in numerical mode on a stream of data of generic type, result of a complicated mathematical processing based, according to a basic principle, on the cyclycity of the human voice. As a matter of fact, it is known that by sampling the human voice on time windows in the order of some milliseconds, the wave form, corresponding to the human voice sampled and transformed in electrical signal, assumes a certain periodicity. During the years, codifiers or audio codecs have been therefore developed, mainly for applications of mobile telephony on mobile and/or satellite network and then also for VoIP, which deal with modeling the human voice through mathematical function translatable into numeric data streams, which use the deconstruction of the human voice according to a plurality of parameters which comprise for example and not limiting to, the sound amplitude in frequency (pitch), the associated gain, or the frequencies of the formants of various phonemes. The analogical data stream which derives for example from a microphone is firstly acquired and transformed into digital, then compressed and finally coded with technique with or without quality loss, such that once decoded and decompressed it is possible to regenerate an audio data stream which is the most possible similar to the original one or, more generally, which keeps at the possible best the understandability of the voice.

There are audio codifiers of various typologies and classes (CELP, MELP, ACELP), of which some are subject to use license. The codecs for modern VoIP applications, which among others are used for mobile telephony applications, generally belong to the AMR-WB class. Technically speaking, these adaptive multirate codifiers, process audio data streams at least at 16 kHz and 16 bit, whose bandwidth is i.e. equal to 8 kHz, considerably larger (hence the name “wide”) with respect to the old codecs with real pass-band of 3.2-4 kHz of previous telephone systems. There are then codes able to manage higher bandwidths and are i.e. able to reproduce even more faithfully audio signals containing components ever higher in frequency, extending themselves further until 20 kHz. These codecs are known in technical jargon with the name of super-wideband or full band.

It is then possible to summarize that at the basis of each good VoIP system, there are at least the following elements:
a good communication network, at least able to retrieve and manage any communication errors (packet loss, jitter, and so on), disconnections and transients, quickly connect two or more users and direct the calls on the best path;
a good codec for audio streams of “speech” type, that is VoIP;
a good system of signaling and managing of calls (among the most known, it is possible to mention as example the SIP protocol—Session Initiation Protocol);
a user interface, which is preferably user-friendly and easy in the use.

As shown in FIG. 1, which shows a schematic block diagram of a VoIP system of known type on a single user side, the systems of known type show an audio transducer assembly 1, which in the example indicated in the figure is constituted by a headset with microphone, which through an amplifier stage or buffer 2, directs the audio stream captured by the microphone to an analogical/digital converter 3, which receives as an input—further than the analogical audio data stream 105 deriving from the amplifier stage or buffer 2—also a clock signal typically deriving from the hardware of the electronic computer upon which is in function the VoIP system or, in case of digital systems such as headsets with microphone for example with USB connection, is internally generated. The audio stream becomes then a numeric data stream (generally in PCM format, Pulse Code Modulation) which is transmitted as an input to a coding macroblock 4 within which it is firstly coded by the audio codec 4a and then processed by a channel codifier 4b for being transmitted to a forward error connection stage (FEC) 5, and then encrypted by an encryption stage or encryption motor 6 (which for example and not limiting to can use an AES-type algorithm or other block encryption algorithms) which receives as an input both the data stream processed by the forward error connection stage (FEC) 5, and by an unknown encryption key 7—which is practically exchanged with all the participants to the same protected conference call (or conference) or, more generally, able to access the multimedia content protected in this way. Subsequently, the data stream is passed at the application level on RTP protocol (RTP block 8), using a system clock signal 9 (SYS CK) in such a way as to ensure the correct management of the data stream as real time communication service on the communication network, typically Internet. The data stream is then sent to a UDP stage 10 which makes a conversion to the UDP protocol and passes the data packets thus processed to the IP stack 11 and then to the network interface controller 12 which physically provides for transmitting the data out of the electronic computer on the Internet network 13, to the network interface controller 14 of the addressee (one or more than one indifferently).

It is to be noted that nowadays the VoIP software applications have further secondary functions such as chat (Instant Messaging) or real time exchange of files. The evolution of software for Voice-over-IP is become such to transform them in real groupware systems of enterprise class, such as for example and not limiting to Microsoft® Lynk® or Skype® in its business declinations.

The Applicant has observed that when a data stream is transmitted on a non protected network such as Internet, from the point of view of safety, there is no difference even if these data refer to a generic environment (data, file transmission, audio and video streaming, and so on) or are specific data of a VoIP communication: the only way to protect the communication from interceptions of others, is not to leave it “free-to-air” by using the encryption and contemporarily ensuring that the encryption key is always under your own control and changes time to time; this implies that for each new communication session also between two same users, the encryption key is never the same and are used then disposable encryption keys or one-time keys. If this cannot be ensured, the communication loses safety even if encrypted. Finally, the encryption without the control of the encryption key does not ensure a sufficient confidentiality level for data exchange, whatever is their nature.

As a matter of fact, even if the encryption key is protected, the encryption carried out on an electronic computer at a software level is not safe: for being safe it should be managed at a hardware level on a self-standing device, and somehow independent from the electronic computer itself, from the beginning to the end of the data transceiving process.

In other words, the Applicant has noticed that as in case of the print screen function of a traditional personal computer, it is always possible to acquire the free-to-air audio streams transmitted by an electronic computer, even if numeric. By directly reading from the audio peripheral of the computer, or by directly reading in the RAM memory the bytes going from and to the audio acquisition and reproduction hardware peripheral (i.e. the audio card), attackers can extract from the data stream the “free-to-air” message through a post-processing of the information acquired in this rather simple way, even using programs widely available on internet.

According to the Applicant, then, the purely software VoIP communication solutions are not safe, even if functioning on a normal personal computer of whatever type or gender, and on a Smartphone, tablet and mobile device of last generation. Therefore, further known VoIP software even as Skype® are not able to provide a sufficient safety in the transmission of audio streams and more generally of media streams, because even if the software itself provides for encrypting the audio data streams, the acquisition and reproduction of the stream itself takes place from a peripheral (the audio card of the device used) which evidently free-to-air transmits and receives, without any native encryption ability, i.e. hardware. Furthermore, the encryption key possibly used is not known to the user, but is directly managed by the producer/creator of the software. It is then unknown to the real user of the VoIP system or, anyhow, of the transmission system and this creates a further intrinsic weakness in the system of safe transmission of the voice audio stream.

The Applicant has further noted that the audio codecs of VoIP communication software are not able to effectively manage an incoming generic data stream, and in particular an encrypted audio data stream even before being encrypted by the codec. The reason is that the most part of the parameters of deconstruction and parameterization of a voice audio signal that are used by functions and algorithms of codecs, is conceived for operating on a signal provided with a certain time periodicity, and not on an encrypted signal whose time correlation and spectrum structure in frequency are strongly different from what occurs for the human voice.

From the WO2013121275 document is known a portable device for data encryption/decryption and/or compression/decompression that comprises at least a support chip for the authentication, at least a first data input/output port adapted to be interfaced with external devices, at least a second data input/output port adapted to be interfaced with external devices; at least a data processing unit that comprises a microprocessor provided with an encryption motor.

The Applicant, through the present invention, intends to realize a portable device for transceiving encrypted audio, video and/or audio and video streams that permits to a user to safely communicate with another user provided with the same device.

More in detail, the purpose of the Applicant is to allow the user to safely communicate with another user using a data transmission network.

Even more in detail, with the present invention the Applicant intends to realize a device and to describe a method that permits said safe reception and transmission by means of pre-existing VoIP software and/or systems.

### SUMMARY OF THE INVENTION

According to the present invention is realized a method for transceiving at least audio encrypted multimedia streams between at least a first and a second user, said method being characterized in that it comprises the use of a multimedia streams transceiving device connected to a respective electronic computer by both the first and said second user; said method comprising a first step of preventive activation of a free-to-air communication session between said first and said second user through a software for making calls within which said device operates in a first free-to-air transmission configuration, and a second step of creation of an encrypted communication, within which said device operates in a second encrypted transceiving configuration by means of an encryption stage or motor; said method comprising a step wherein said device causes the opening of a session for transferring encrypted data between the electronic computers of said first user and said second user different from the free-to-air communication session used by said software for making calls, and wherein an at least audio data stream transceived between the two users during their communication is selectively switched between said free-to-air communication session and said encrypted data transfer session on the basis of a predefined criterion.

Advantageously, said free-to-air data communication session used by said software for making calls is kept open during said encrypted data transfer session.

Advantageously, said predefined criterion comprises the transmission of an identification code, alternatively carried out by one of the two devices involved in said communication between said first and second user; said transmission of said seed code occurring by means of a communication session previously opened by means of said software for making calls.

Advantageously, said seed code causes the selection of an encryption code previously registered in a memory of both said devices; said encryption code being kept secret on each of said devices and being used for carrying out the encryption of said audio data stream.

Advantageously, said encrypted data transfer session causes a transceiving of said encrypted data on a data transmission network susceptible of permitting the connection between said first and said second user.

In detail, the creation of said free-to-air communication session comprises a step of introduction of an audio transducer means in a input/output port or interface of said multimedia streams transceiving device before the creation of said communication session of encrypted data transfer, and further comprises a step of connection of said multimedia streams transceiving device to an electronic computer through a communication port, said connection causing the presentation of an audio interface to said electronic computer susceptible of selecting said media streams transceiving device as input/output peripheral of audio streams received, transmitted or directly processed by said electronic computer.

According to the present invention is furthermore realized an encrypted audio streams transceiving device, said device comprising:
at least an input/output port or interface for data streams at least of audio type susceptible of being free-to-air transmitted and/or received from/to transducer means,
at least a connection port or interface with an electronic computer, said connection port or interface being configured for permitting at least the transmission and/or reception of an at least audio encrypted data stream from and/or to said electronic computer respectively;
an encryption stage or motor, electrically connected to said input/output port or interface and to said connection port or interface, and configured for providing and respectively receiving to/from said connection port or interface an encrypted data stream containing at least audio type data;

and wherein said device is configured for presenting to said electronic computer an at least audio data transceiving interface; said device sending to said electronic computer, according to a predefined criterion, a command for the switching of the transceiving of said at least audio data stream transceived from/to said at least an input/output port or interface.

In detail, the device is configured for permitting the transmission of said audio and/or video data stream through said free-to-air audio and/or video data transceiving interface to a pre-existing communication software, preferably of VoIP type, susceptible of interconnecting at least a first user to a second user; said device being configured for receiving a switching command to a session of encrypted communication; said encryption stage or motor being activated by said switching command or signal.

Advantageously, said audio and/or video data transceiving interface is a Audio Class type interface.

Advantageously, said encryption stage or motor operates an encryption of said audio and/or video data stream with a key used once, selected on the basis of a seed code signal shared with a second user of the same device and generated starting from a common secret between the devices and already prior known as well as from the mutual specific data exchange between said device and a further device involved in the communication.

Advantageously, said specific data comprise at least an identification code exchanged with a further device before the creation of said session of encrypted communication, wherein the exchange of said identification code occurs on a session previously created by communication software, and wherein said device is configured for transmitting an opening request of said encrypted session for the packet data transceiving to a further electronic computer, said packet data comprising said encrypted data stream exchanged between said device and said electronic computer through said communication port or interface.

Advantageously, said packet data transceiving session is a session based on a UDP type communication protocol.

In detail, said device is configured for causing the keeping of the opening of a communication session previously opened by means of said communication software during the transmission of said encrypted data stream upon said encrypted session for packet data transceiving.

In detail, said device is advantageously configured for causing the transmission of a dummy signal to said communication software.

Said dummy signal is advantageously selected between a white noise and/or said seed code.

Advantageously, the device comprises an audio coding stage having an input supplied with a numeric data stream comprising at least an audio data stream received from audio transducer means electrically connected to said input/output port; said audio coding stage comprising coding and/or decoding and/or audio compression/decompression means specifically configured for carrying out a numeric processing of said data based on the voice coding.

In detail, said coding means are vocoders of the type or derived from Code-Excited Linear Predictor, Mixed-Excitation Linear Prediction or Algebraic Code-Excited Linear Prediction.

Advantageously, eventually, said device further comprises a receiving analogical/digital conversion stage having an input supplied by said input/output interface or port and an output supplying said input of said audio coding stage with said numeric data stream comprising a transformation in the digital domain of said audio stream.

### DESCRIPTION OF ATTACHED FIGURES

The invention will be now described with reference to the attached figures wherein:

FIG. 1 shows a block scheme of a system of transmission of audio streams of voice-over-IP type of known type;

FIG. 2 shows a block scheme of the encrypted audio streams transceiving device object of the present invention, when connected to an electronic computer;

FIG. 3 shows a diagram representing a plurality of interfaces that are presented to the electronic computer when the device object of the present invention is connected thereto;

FIG. 4 shows a simplified block scheme wherein a first and a second user communicate between them by means of respective assemblies comprising a his electronic computer and a his device object of the present invention according to a peer-to-peer type configuration;

FIG. 5 shows an example block scheme of the switching between a communication session between said first and second user through a VoIP software installed on said electronic computer and a safe communication session wherein the data stream is firstly encrypted by said device object of the present invention;

FIG. 6 shows a diagram representing the coexistence of a first communication session managed by said VoIP software and a second safe communication session managed through the device object of the present invention;

FIG. 7 shows a scheme similar to the one of FIG. 4, but wherein the communication between the two users occurs on a client/server type system.

### DETAILED DESCRIPTION OF THE INVENTION

### Definitions

According to the present invention, with electronic computer it is to be intended any electronic system or device able to exchange a data stream, preferably but not limiting to a packet through a whatsoever channel of communication with another electronic system or device of the same or different type; said electronic computer must have a data processing unit or microprocessor able to cause the re-transmission at least partial of said data stream to an external hardware device—specifically the device object of the present invention—through a digital communication port; consequently, a non exhaustive list of electronic devices able to be considered “electronic computers” according to the present invention comprises personal computers, desktop type computers and workstations or server type computers, tablet PC or portable type computers, using any operating system of free type (Linux, and so on) or subject to use under license (Windows, Mac OS, and so on), mobile phones of Smartphone type, and so on.

According to the present invention it will be made reference to streams of numeric or digital data of media or multimedia type for defining audio and/or audio video data streams.

According to the present invention with the VoIP or Voice-over-IP acronym is defined the assembly of digital communication protocols and of technologies able to permit a telephone and/or audio video conversion on a Internet network or on further types of packet switching networks wherein are used, generally but not limiting to, protocols without connection (IP type protocols of UDP type datagram class) for the transport of numeric data, not relating to the analogical domain.

It is to be noted that even if during the present invention it is made reference to a preferred embodiment of macro-system of transceiving of safe communications through the Internet network, this specific typology of data exchange network is not to be intended as limiting as unique support channel of data transmission. As a matter of fact, the electronic computer above described can transmit information on any network of data transmission and, consequently on a transmission channel, even if not cabled or not physical such as for example the mobile telephone network, the satellite telephone network or a private radio/mobile network, or further a geographical type network such as Internet or a virtual private network (VPN), an Intranet network, a local network (LAN) or further personal (PAN) realized through wireless technologies such as Bluetooth, Wi-Fi and so on.

During the present invention differences are shown between free-to-air transmissions and encrypted transmissions; the “observation” point of encryption is positioned at the input of each electronic computer which is described during the present invention. Thus are to be intended as “free-to-air” all the communications encrypted at software or hardware level within the electronic computer and/or directly by the VoIP software program, or further all the communications which are not encrypted at all. Vice versa, the encrypted transmissions are those whose encryption operation is made by hardware and/or software external with respect to the electronic computer itself.

Description of the Device

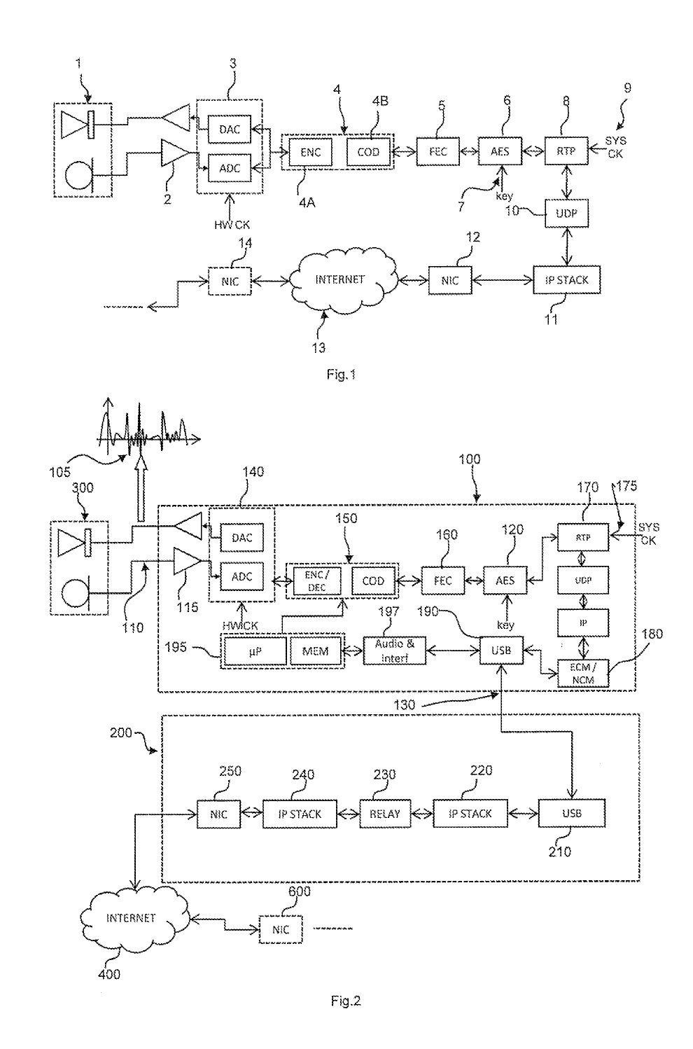

As shown in FIG. 2, with reference number 100 is indicated in its entirety an encrypted media streams transceiving portable device that is configured for permitting a media or multimedia data transceiving at least of audio type with protected communications between a first and a second user positioned in remote positions, each one equipped with an electronic computer 200 to which connect a respective device 100; said electronic computers 200 are connected between themselves on a data transmission network 400.

The preferred and not limiting form of embodiment of the device 100 object of the present invention comprises a first input/output port or interface 110 for audio stream, that supplies as input a buffer or amplifier stage 115 whose output is electrically connected to a analogical/digital conversion stage 140, that receives as input a HW CK clock signal deriving from a generator inside the device object of the present invention. The purpose of the analogical/digital conversion stage 140 is to convert the audio stream that is in the analogical domain into a numeric data stream that can be susceptible of being encrypted through a series of processing that will be hereinafter described in detail.

Preferably, even if not limiting, the first input/output port or interface 110 is a female jack for the connection of a headset/microphone set, but this connector typology must not be intended in a limiting way; the definition of “interface” thus detects further those connections with wireless-type headset/microphone sets, or with other ports different from a traditional audio jack such as for example, but not limiting to it, the USB interface.

After the analogical/digital conversion stage 140 is then created a data stream of numeric type continuous during the time and whose content represents the digitalization of the analogical signal 105 captioned or transmitted by transducer means 300, represented for example by an assembly of headset and microphone electrically connected to the input/output port 110, that can be specifically and not limiting to it a jack connector of female type, traditionally used for the connection of headset with microphone.

The analogical/digital conversion stage 140 supplies an input of an audio coding stage 150 that comprises an audio encoder and a channel codifier. Preferably, even if not limiting, the audio coding stage 150 is a vocoder of linear prediction type, of Code-Excited Linear Predictor, Mixed-Excitation Linear Prediction or Algebraic Code-Excited Linear Prediction type. Successively, the audio coding stage 150 sends the coded data stream to a FEC coding stage 160, that provides for processing the numeric data stream introducing for example redundant bits to the digital stream constituted by numeric data stream.

The data stream thus encrypted is transmitted to an encryption stage 120 that comprises in its inner an encryption motor, preferably operating on data blocks such as in case of AES, DES, 3DES, Ghost coding.

Through the coding stage 120, it is implemented an encryption of the data stream with a encryption key of disposable type session, such that with equal number of users, each new communication session is encrypted with a different key. More in detail, the key used for the data stream encryption is selected on the basis of a seed code (or seed) that is the only one to be transmitted on the communication channel between the two electronic computers 200 of the first and second user. The encryption key is derived from said seed code, that is one time transmitted and is therefore defined as number at once (nonce) and is preferably generated by whom starts the communication. The seed code or number at once is generated too by the encryption stage 120 and is preferably represented by a high entropy number of 256 bits.

The encryption key is derived from said number at once through a function of non objective hashing of SHA 256 or higher type.

It is to be noted that given that the AES256 is a block encryption protocol conceived for operating on data blocks of a predetermined dimension, its adaptation is necessary in order to make it compatible with a numeric data stream containing data of at least audio type, even if encrypted and/or processed; as a matter of fact, this data stream has the characteristics specific of a stream, wherein the various audio frames have a very little and typically variable dimension; the processing made on the encryption algorithm is advantageously and not limiting, a standard technique of styling ciphertext.

The data stream processed by the encryption stage 120 is transferred to application level on RTP protocol (RTP 170 stage), using a system clock signal 175 in such a way as to ensure the correct management of the data stream as service of real time communication on variable and not predetermined latency networks, such as Internet. Therefore, the data stream processed in this way is sent to an input of a ECM stage 180 (Ethernet Control Model) and from it to a USB controller 190, that transmits the data stream thus processed on a communication port 130 that even if described and shown as USB port can be any data communication port or interface between an hardware device and an electronic computer, further not of cabled but wireless type. The ECM stage 180 can be equivalently replaced by a NCM stage (Network Control Model), further able to manage Ethernet-over-USB connection sessions. The audio data stream is then previously encrypted and outside of the electronic computer 200; once said stream is transmitted to the computer itself, the task of it is substantially only to transfer it to the other user involved in the safe communication.

When the device 100 object of the present invention is electrically connected to an electronic computer 200, the data stream transmitted by the device 100 object of the present invention is sent to a stage cascade comprising a internal USB controller 210, that supplies an input of a IP stack module 220, that in turn exchanges data with a relay stage 230, then to an IP stack 240 and to a network interface stage 250, that permits the output of the processed data to the communication network 400, and from this to the electronic computer of the other user of the communication, firstly encountering its network interface 600 and then the other blocks in the sequence identical and opposed with respect to what has been already described.

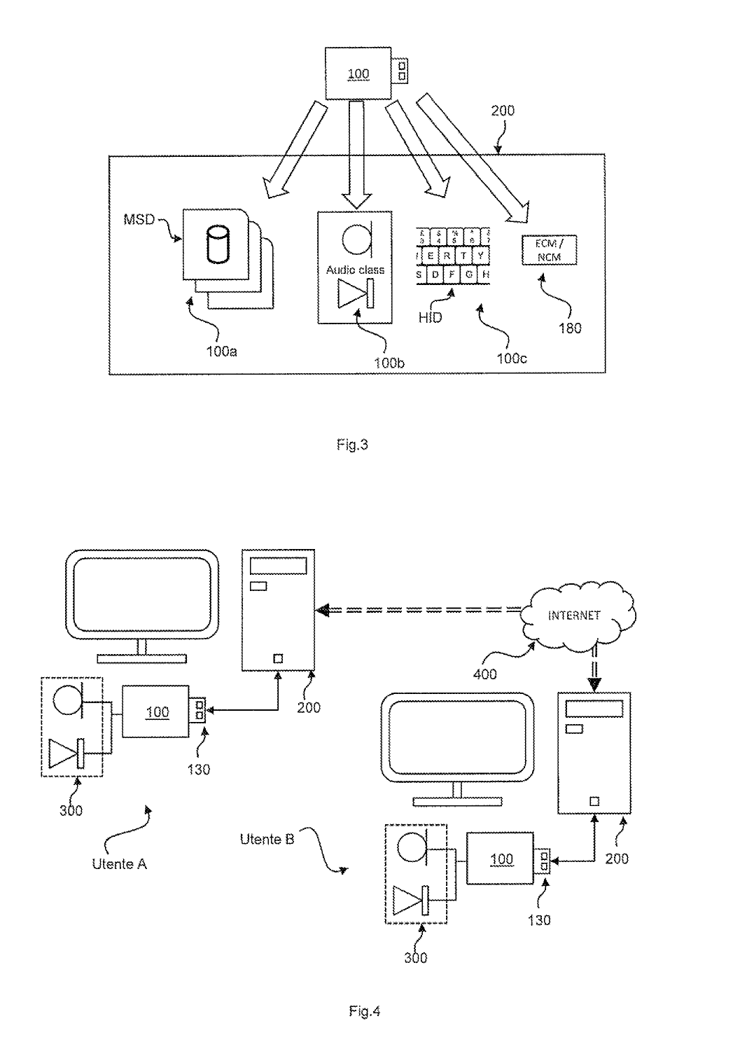

As shown in FIG. 3, the device 100 object of the present invention, during the connection with the electronic computer 200 is shown as a plurality of interfaces. In detail, these comprise at least: an MSD type interface or Memory Storage Device 100a, that is typical for example of a USB key, a HID type interface 100c and an Audio Class type interface 100b. This last audio interface is selectively enabled by a microcontroller inside the device 100 object of the present invention and comprises a first registration under-interface and a second reproduction under-interface, and is in detail configured for transmitting a message of signalization of the intention to start a protected call to the other user. Through the Audio Class type interface 100b the VoIP software 500 identifies the device object of the present invention as audio interface. As a matter of fact, the Audio Class type interface 100b is shown to the electronic computer 200 at the moment of the connection of the device 100 through the connection port or interface 130; at the moment of the connection, the device 100 object of the present invention is configured for providing further information on the presence or absence of transducer means 300 connected or not to the input/output port or interface 110. This type of information belongs to the management standard of audio peripherals for all the systems available on the market and is equally managed by all the operating systems of the various electronic computers. In particular, at the moment of the connection of headset/microphone set in the input/output port or interface 110, the event is notified by the device 100 to the electronic computer 200 and this causes the switching of the audio data stream from and to the device 100 rather than from the previous transducer means used by the electronic computer.

The device object of the present invention is characterized in that it can interface itself with VoIP type software 500 of pre-existing type and installed on the electronic computer presenting itself as audio device for reproduction and registration (i.e. more easily but not limiting: “headset with microphone”) in order to determine a safe and encrypted communication starting from a traditional type communication. Thus, when the device 100 is used for carrying out a communication between a first user A and a second user B, the global structure has the form shown in FIG. 4, wherein starting from the headset/microphone set that identifies the transducer means 300, the audio signal is sent and received in bidirectional way, and in detail in preferably full-duplex mode, to the device 100 according to the present invention and from it to the electronic computer 200, for then transiting on the communication network 400 to the electronic computer 200 of the second user and then to his headset/microphone set through the respective device 100. This occurs while the device 100 continues to keep active, to the pre-existing VoIP software 500, its Audio Class interface, such that it can in turn keep activated the free-to-air communication channel upon which are directed, advantageously but not limiting, white noise or other audio signals generated from the device 100.

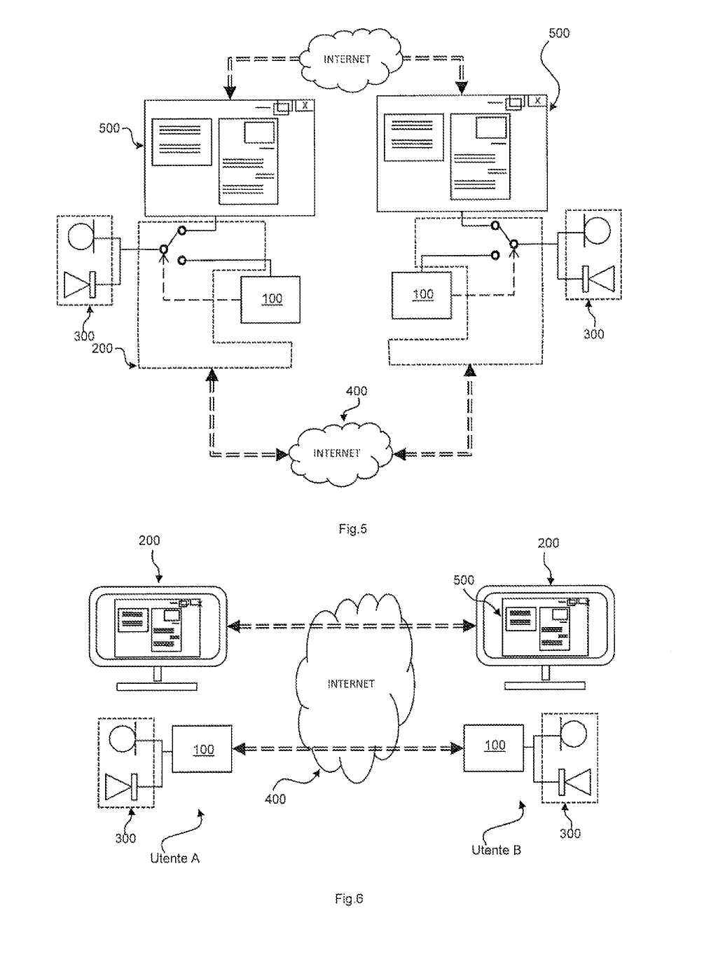

In order to realize all, the device 100 according to the present invention permits a beginning of a traditional type communication, using the pre-existing VoIP software, for then switching according to a predetermined criterion on a protected communication, that is initialized on a data transmission session separated from the one used by the software VoIP 500 and wherein the encryption of the data stream is carried out outside with respect to the electronic computer, and i.e. inside the device 100 as above described. The FIG. 5 shows a simplified schematic representation of this switching; it is substantially as if in each electronic computer 200—device 100 assembly there is a virtual switcher able to make an audio stream switch between the pre-existing VoIP software 500 and the device 100 object of the present invention, using the same communication network but opening a data transceiving session different from the previous one.

Advantageously, whereas the device 100 makes safe the audio stream acquired as an input from the transducer 300, the device 100 itself continues to keep active the free-to-air audio channel to the pre-existing software reproducing white noise and/or other audio signals.

During the encrypted data transmission, the communication with the pre-existing VoIP software is kept open, and on the session managed by the VoIP software is transmitted preferably but not liming a white noise.

More in detail, it is through the VoIP software 500 pre-installed on the electronic computer 200 that is possible to transmit the identification code used for selecting the correct encryption key used by devices 100 involved in the communication; furthermore, the start of a “free-to-air” communication through the VoIP software pre-installed on electronic computers 200 is necessary, because it cannot be possible as alternative by part of the called user to know who is calling him and when to start the encrypted communication session. In particular the “free-to-air” term above indicated must not be intended as referred to a VoIP software that does not encrypt in any way the data stream sent on its communication session, but an encrypted data stream from software encryption means inside the electronic computer 200 itself, that are however not able to ensure the correct protection from virus and malware attacks according to what has been previously said.

Eventually, the device 100 object of the present invention can preferably comprise an internal memory 195, controlled by a microprocessor, containing a plurality of pre-registered audio messages, among which a message of waiting of safe communication creation M2, a message of safe call request M1, a message of answer to the safe call request M3 and a message of keeping of the pre-existing VoIP communication M4 that are used by the device itself and transmitted to the electronic computer 200 through the communication port or interface 130 during the initialization process of the safe communication session and during the carrying out of said safe communication. Other details of these messages will be hereinafter described.

For easiness of representation, memory and microprocessor are grouped into a unique block and are electrically connected both with the coding stage 150 (in order to quantify and/or compress the messages predefined before the sending to the electronic computer) and with the USB controller 190, in this last case by means of an audio interface stage 197 that is configured to permit the showing of the Audio Class type interface 100b to the electronic computer when the device 100 is connected to the electronic computer 200.

The device object of the present invention is configured as able to correctly operate both if the two electronic computers 200 are in a peer-to-peer type configuration, and if they have a client/server type configuration. In order to better describe the functioning logic of the device object of the present invention, it will be hereinafter described an example of a call between a first user A and a second user B using each one a device 100, firstly according to a P2P type configuration as the one shown in FIG. 4 and successively with a client/server type configuration, shown instead in FIG. 7.

In the P2P configuration at least one of the two users A and B is preferably equipped with an electronic computer 200 having Internet connection characteristics such as for example and not liming to the possibility of data downloading and uploading, minimum latency, ability to accept incoming connections such as to operate as temporary server in the communication.

At first, the first user A connects his device 100 to his electronic computer 200 and his headset/microphone directly in the device 100. At this point the first user A activates the VoIP software preinstalled on the electronic computer, checking if the second user B he wants to call is online or not. If so, he calls him following the traditional call procedure defined by VoIP software. Up to this moment, the device 100 receives the audio data stream deriving from the computer as it was a simple buffer, being that it is seen by the electronic computer 200 as audio interface; in other words, for the moment it does not introduce any encryption processing, thus carrying out only the coding and decoding of the data stream and its conversion between analogical domain and digital domain.

The user B, who has not yet the device 100 connected to his electronic computer 200, sees that his VoIP software rings and decides to answer. Up to this moment, the user B does not know if the first user A is “free-to-air” calling him or not, because this information is not managed by the VoIP software. Nonetheless, the device 100 of the first user A does not absolutely know with which further device 100 it has to connect.

The second user B answers to the call through his VoIP software, and through the speakers of his computer or any further active audio peripheral, receives the message of safe call request M1 previously indicated that is transmitted by the device 100 of the first user A; this message can be for example a voice message that recites: “Incoming encrypted VoIP call; please connect your encryption device to the electronic computer”.

At this point, the second user B connects through the connection port or interface 130 his device 100 to the electronic computer 200, preferably and not limiting to introducing an access code or credentials that in the preferred form of embodiment here described is represented by a username/password pair or by a single master password/pin.

During this time period between the first user A and the second user B is not yet present a “safe” communication, and the user A receives on his transducer means 300 a waiting call signal or alternatively the message of answer to the safe call request M3 deriving from the device 100 supplied to the second user B, for example: “Please wait; your contact is completing the safe communication connection” as well as possibly, in turn, the message M1 itself sent by the user B.

It is to be noted that as long as the second user B does not connect a headset/microphone set to his device 100, the device 100 does not show its audio interface to the electronic computer; consequently, the audio is managed by the audio interface previously selected as predefined by the electronic computer itself, and no audio data stream is addressed to the device 100 object of the present invention as long as the headset/microphone set is not activated through the insertion in the input/output port or interface 110.

It is then important that during the phase of reception of a call, the device 100 object of the present invention does not show itself immediately to the electronic computer; if it were so and if the user B had not the headset/microphone set already connected to the device 100 through the input/output port or interface 110, he could not hear anything.

At this point, the second user B connects his headset/microphone set to his device 100, the device 100 detects this connection and commands its microcontroller for free-to-air transmitting, to said VoIP software, an audio data stream that contains a message of identification of creation of a safe VoIP call, i.e. wherein the encryption is carried out outside of the electronic computer 200. This message of waiting of creation of a safe communication M2 can be for example: “Initializing safe call, please wait while the call is creating”.

Through the predetermined audio messages transmitted through the VoIP software, message that can be purely voice and/or containing a tone code for example audible DTMF, each device 100 connected to the call detects which is the other calling device through the reception of a univocal identification code (ID). In particular, the two devices 100 involved in the call succeed into automatically detect the start of the VoIP call thanks to the start and stop signalizations received by the operating system of their electronic computer 200. Therefore substantially when the second user B answers to the call, both the VoIP software (both of the first and of the second user) start the endpoint or the registration under-interface of the audio interface shown by the device 100 and, after having detected this event, both the devices 100 start to reproduce the audio message by adding their univocal identification code.

If the ID identification code of the device 100 of the first and/or second user is blurred transmitted in one of the predefined audio messages, a steganography technique applied to voice audio streams is used; vice versa, if the ID identification code is transmitted with a modulation technique of DTMF standard type, there will be a plurality of predetermined values (typically but not limiting to from 0 to 15) that are introduced in the data stream before its encoding through the audio encoding stage 150 by modeling signals at different frequencies opportunely artificially synthesized of the device 100 object of the present invention.

It is then opened a second safe communication session, wherein firstly the two devices 100 involved in the communication exchange their seed codes used in turn for deriving the univocal encryption key of the safe communication session that is going to be created starting from an already known common secret contained in both the devices and selected thanks to the univocal identification code previously received.

In this way, both the devices 100 switch the communication on a safe session different with respect to the one used by the VoIP software, and provide for converting, encoding and encrypting the original audio stream by using the whole stage chain previously described and shown in FIG. 2, by sending digital data packets containing said encrypted audio message to the electronic computer 200 and consequently the device 100 of the opposed user. It is to be noted that the created communication is of full duplex type. The VoIP software program continues to receive a free-to-air audio stream, preferably but not limiting a white noise, and contemporarily possible malwares, virus or Trojan present in the electronic computer are not minimally able to access to the content of the safe communication created thanks to the encryption carried out by the device object of the present invention. When the two electronic computers 200 are connected on an internet network, they exchange the data packets containing the encrypted data stream in the P2P configuration basing themselves on the UDP network protocol with a data stream managed according to the RTP application level (Real-Time Transport Protocol, ISO/OSI application layer), that represents the most commonly used standard for the transmission of streams of audio or video stream type data; the use of UDP protocol for the support of the RTP is not to be considered as limiting; as a matter of fact, it can be further supported by a TCP type protocol or of other typology, even if it is more oriented to the keeping an integrity of packets instead of their time aligning.

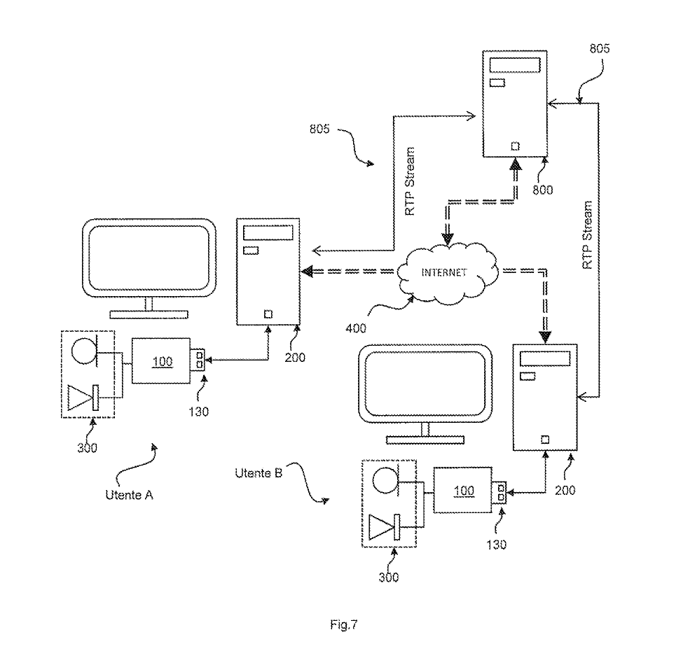

During all the safe communication session, the previous communication session opened by the VoIP software is kept open, and therefore there are two communication sessions contemporarily open, as shown in FIG. 6, wherein a first is the standard one managed by the VoIP software program. On this session can be transmitted for example and not limiting to it, a white noise or a further data stream not related to the communication between the two users A and B, such as for example a message of keeping of VoIP communication that is repeated at regular time periods.

In the example and not limiting case shown in the attached figures, it is to be noted how the safe communication occurs between two users connected through respective electronic computers 200 on an Internet communication network 400. In this solution the data packets that contain the encrypted audio signal, move on the Internet network directly to the receiver electronic computer or they pass in relay on an external server alternatively. This further passage, that is optional and depends on the structure or on the configuration of the network, makes it necessary that if the electronic computers 200 (that represents the endpoints) do not succeed into creating a direct communication between them as it would happen for a peer-to-peer, it should be used an intermediate “recovery” service that is generally given to a dedicated server; this dedicated server, in VoIP systems, is the so-called “conference server”.

Finally, in FIG. 7 is shown a configuration of the communication between the first user A and the second user B according to a client/server type scheme. In detail, the method of creation of the encrypted communication session in this configuration is very similar to the one previously described for the case of the peer-to-peer configuration; however, the sending of data packets using the UDP network protocol (or tCP, as above described) and the RTP transport protocol is not directly carried out in this case between the two electronic computers 200 on the Internet network; they are instead sent to a centralized control server 800, that manages for each one of the two electronic computers 200 both the incoming data streams and the outcoming data streams, and distributes them to the correct receiver. In the client/server configuration it is then easier to implement virtual conference rooms wherein a plurality of users, even higher than two, can talk having the security that no malware, virus or Trojan present on the electronic computer can intervene in malicious way, detecting their private conversation.

When the communication between the first and second user ends, both the communication sessions previously created are closed and each of the users is then free to stop the VoIP software 500 and to disconnect the device 100 object of the present invention form his electronic computer. Furthermore, when one of these users ends the communication session by directly acting on the pre-existing VoIP software, the architecture of the encryption device object of the present invention permits to automatically close the safe communication sessions previously created.

The advantages of the device 100 object of the present invention are clearer in the light of the previous description. As a matter of fact, it permits to users to carry out safe communications by using traditionally known software, without the user carrying out complicated operations for creating a safe communication. In particular, the device described in the present description is not limited to the use with specific software, being able to adapt itself without changes to any software or program for computer able to create a multimedia type communication and, specifically but not limiting, of VoIP type.

Advantageously, if the user wants to stop said safe communication, he can easily and quickly return on the free-to-air communication by using the VoIP communication software that can stay open and then active for all the duration of the safe communication. The user can equally do the contrary, i.e. pass from a created free-to-air communication already active through the VoIP communication software to a encrypted and protected communication by simply inserting his encryption device with related local audio peripheral connected to it.

Advantageously, the device according to the present invention has a little size, is outside of the electronic computer and can then be easily transported and used on electronic computers as previously defined independently from their producer or the operating system used by them. This advantage is particularly given by the fact that the device object of the present invention is provided with a USB type communication port, which nowadays is the most used standard communication port in the world of informatics electronics. However, the device object of the present invention can be equipped with other typologies of interfaces to the electronic computer both of electro-mechanic type and wireless type.

Advantageously, the device according to the present invention does not permit to intruders to easily access to the safe communication, because both the encryption keys and the encryption procedures are safely contained in its inner, outside of the electronic computer. In this way, the traditional malware, spyware, virus or Trojan that can be functioning in the electronic computer cannot access it. This is very different from the common data and voice software protection systems where both the encryption key and the possible encryption algorithm are totally in the functioning electronic computer in the part of RAM memory wherein the communication software used by the user is functioning.

In particular, even if the electronic computer is infected by malicious programs able to capture audio and/or audio and video streams and even if the user himself continues to use his own pre-existing communication software, the device described up to this point further permits that the communication is automatically and totally protected at hardware level not anymore by the pre-existing communication software, functioning in the memory of the electronic computer, but by the external device object of the present invention.

Advantageously, the device object of the present invention can be finally used with any type of headset provided with microphone or be equally connected to a set of speakers and microphone of the type traditionally available on the market.

Advantageously, the device according to the present invention can further protect video or audio and video type communications by means of the same functioning logic and the connection to its own communication ports of various external devices such as USB webcams, Ethernet webcams, cameras and video-conference systems able to communicate on IP networks and connected to these networks and/or directly to the device itself through cabled or wireless interfaces and so on.

It is finally clear that to the device 100 described up to this point can be applied additions or variants obvious for an expert in the art without exiting from the protection scope provided by the attached claims.

1. An encrypted multimedia streams transceiving method between at least a first and a second user, said method being characterized in that it comprises the use of a multimedia streams transceiving device (100) connected to a respective electronic computer (200) by both the first and said second user; said method comprising a first step of preventive activation of a free-to-air communication session between said first and said second user through a software for making calls (500) within which said device (100) operates in a first free-to-air transmission configuration, and a second step of creation of an encrypted communication, within which said device (100) operates in a second encrypted transceiving configuration by means of an encryption stage or motor (120);
said method comprising a step wherein said device (100) causes the opening of a session for the transfer of encrypted data between the electronic computers (200) of said first user and said second user different from the free-to-air communication session used by said software for making calls, and wherein a data stream at least transceived between the two users during their communication is selectively switched between said free-to-air communication session and said encrypted data transfer session on the basis of a predefined criterion.

2. A method according to claim 1, wherein said free-to-air data communication session used by said software for making calls (500) is kept open during said encrypted data transfer session.

3. A method according to claim 2, wherein said predefined criterion comprises the transmission of an identification code, alternatively carried out by one of the two devices (100) involved in said communication between said first and second user; said transmission of said seed code occurring by means of a communication session previously opened by means of said software for making calls (500).

4. A method according to claim 3, wherein said seed code causes the selection of an encryption code previously registered in a memory (120) of both the devices (100); said encryption code being kept secret on each of said devices (100) and being used for carrying out the encryption of said audio data stream.

5. A method according to claim 1, wherein said encrypted data transfer session causes a transceiving of said encrypted data on a data transmission network (400) susceptible of permitting the connection between said first and said at least second user.

6. A method according to claim 1, wherein the creation of said free-to-air communication session comprises a step of connection of an audio transducer means (300) on a input/output port or interface (110) of said multimedia streams transceiving device (100) before the creation of said encrypted data transfer communication session, and further comprises a step of connection of said media streams transceiving device (100) to an electronic computer (200) through a communication port (130), said connection causing the presentation of an audio interface to said electronic computer (200) susceptible of selecting said media streams transceiving device (100) as input/output peripheral of multimedia stream received, transmitted or directly processed by said electronic computer (200).

7. A device (100) for transceiving encrypted multimedia streams, said device comprising:
at least an input/output port or interface (110) for data stream at least of audio type susceptible of being free-to-air transmitted and/or received from/to transducer means (300),
at least a connection port or interface (130) with an electronic computer (200), said connection port or interface (130) being configured for permitting at least to transmit and/or received a data stream at least audio encrypted from and/or to said electronic computer (200) respectively;
an encryption stage or motor (120), electrically connected to said input/output port or interface (110) and to said connection port or interface (130), and configured to provide and respectively receive to/from said connection port or interface (130) an encrypted data stream containing at least audio type data;
and wherein said device (100) is configured to present to said electronic computer (200) an at least audio data transceiving interface; said device (100) sending to said electronic computer (200), according to a predetermined criterion, a command for the switching of the transceiving of said at least audio data stream transceived from/to said at least one input/output port or interface (110).

8. A device according to claim 7, configured for permitting the free-to-air transmission of said audio and/or video data stream through said audio and/or video data transceiving interface to a pre-existing communication software (500), preferably of VoIP type, susceptible of interconnecting in a communication at least a first user with a second user; said device being configured for receiving a switching command to an encrypted communication session; said encryption stage or motor (120) being activated by said switching command or signal.

9. A device according to claim 8, wherein aid audio and/or video data transceiving interface is an Audio Class type interface.

10. A device according to claim 9, wherein said encryption stage or motor (120) carries out the encryption of said audio and/or video data stream with a key used only once, selected on the basis of a seed coding signal shared with a second user of the same device (100) and generated starting from a mutual exchange of specific data between said device (100) and a further device (100) involved in the communication.

11. A device according to claim 10, wherein said specific data comprise at least an identification code (ID) exchanged with a further device (100) before the creation of said encrypted communication session, wherein the exchange of said identification code (ID) occurs on a session previously created by a communication software (500), and wherein said device (100) is configured for transmitting a request for opening said encrypted session for transceiving packet data to a further electronic computer (200), said packet data comprising said encrypted data stream exchanged between said device (100) and said electronic computer (200) through said communication port or interface (130).

12. A device according to claim 11, wherein said packet data transceiving session is a session based on a UDP type communication protocol.

13. A device according to claim 11, configured for causing the keeping of the opening of a communication session previously opened by means of said communication software (500) during the transmission of said encrypted data stream on said encrypted packet data transceiving session.

14. A device according to claim 13, configured for causing the transmission of a dummy signal to said communication software (500).

15. A device according to claim 14, wherein said dummy signal is a white noise and/or said seed code.

16. A device according to claim 7, comprising an audio coding stage (150) having an input supplied with a numeric data stream comprising at least an audio data stream (101) received by audio transducer means (300) electrically connected to said input/output port (110); said audio coding stage (150) comprising audio coding and/or decoding and/or compression/decompression means specifically configured for carrying out a numeric processing of said data based on the voice coding.

17. A device according to claim 16, wherein said coding means are vocoders of the type or derived of Code-Excite Linear Predictor, Mixed-Excitation Linear Prediction or algebraic Code-Excited Linear Prediction.

18. A device according to claim 16, further comprising a receiving analogical/digital conversion stage (140) having an input supplied by said input/output port or interface (110) and an output supplying said input of said audio coding stage (150) with said numerical data stream comprising a transformation of the digital domain of said audio stream.

19. A device according to claim 7, wherein aid audio and/or video data transceiving interface is an Audio Class type interface.

20. A device according to claim 7, wherein said encryption stage or motor (120) carries out the encryption of said audio and/or video data stream with a key used only once, selected on the basis of a seed coding signal shared with a second user of the same device (100) and generated starting from a mutual exchange of specific data between said device (100) and a further device (100) involved in the communication.
